(19) United States
(12) Patent Application Publication
(10) Pub. No.: US 2006/0131971 A1
(43) Pub. Date: Jun. 22, 2006

(54) Synchronous motor with starter device

(75) Inventors: Werner Hangmann, Oerlinghausen (DE); Oliver Grote, Lage (DE); Norbert Krogmeier, Bielefeld (DE)

Correspondence Address: RICHARD M. GOLDBERG, 25 EAST SALEM STREET, SUITE 419, HACKENSACK, NJ, 07601, US

(73) Assignee: Hanning Elektro-Werke GmbH & Co. KG, Oerlinghausen (DE)

(21) Appl. No.: 11/303,731

(22) Filed: Dec. 16, 2005

(30) Foreign Application Priority Data
Dec. 17, 2004 (DE) 10 2004 060 872.5

(51) Int. Cl. H02K 7/18; H02K 7/06; H02K 7/10

(52) U.S. Cl. 310/75 C; 310/80

(57) ABSTRACT

A synchronous motor includes a starter device in the drive connection between the motor and a load, and a driven rotor. In the drive train between rotor and the load there is a shaft element inside which there is a cylindrical chamber in which a coaxial shaft is rotatable mounted, and on which a threaded portion is disposed in a torque-proof but axially displaceable manner. A nut (38) meshes with the threaded portion, the nut being arranged in the chamber in a torque-proof but axially displaceable manner.

The invention concerns a synchronous motor with a starter device in the drive connection between the motor and a load, with a driven rotor of the motor.

So-called synchronous motors, i.e. electric motors with a permanent magnetic rotor surrounded by a coil disposed on a stator core are considerably less expensive to manufacture than asynchronous motors. Their disadvantage, however, is that they have very low starting torque.

Hence there are numerous prior art coupling devices to produce a drive connection between the synchronous motor and the loud to be driven, for example the feed pump of a dishwasher machine, once the rotor of the synchronous motor has moved through a certain angle of rotation.

Once the rotor has moved through a certain angle of rotation, it can overcome the inertia of the load, and carry the latter with it. Another problem of synchronous motors is that they have no defined direction of rotation, and may thus start in either direction. If, for example, a synchronous motor is used to drive a pump, the pump usually has to be rotated in a certain direction to work at optimum capacity. A hydraulic trick is frequently used to ensure the motor starts in the right direction of rotation. After accelerating in the wrong direction, the motor is overloaded so that it stops, and the start procedure is then repeated until the correct direction of rotation is achieved. The number of start attempts required before attaining synchronism and the right direction of rotation can be reduced by means of a greater angle of free run in the drive.

DE 38 39 752 A1 describes just such a coupling device, also referred to as a starter coupling in that printed document. This prior art starter coupling has a threaded portion on the output shaft of the motor, with which a nut engages, said nut being connected to a load in a torque-proof manner, but displaceable in the axial direction. The axial displacement of the nut in relation to the load is possible up to a given limit value.

If the threaded portion is rotated, the nut, being engaged with the thread. Is displaced in the axial direction until it comes up against a stop. This coming-together ensures that the output shaft and the load are connected in a torque-proof manner.

The disadvantage if this prior-art solution is that the displacement path of the nut is limited because the thread pitches have to be contrived in such a way that absolutely no self-inhibition occurs. If, on the other hand, it greater free run is wanted before the coupling engagement occurs, a correspondingly long threaded portion has to be used, and this has an unfavorable impact on the dimensions of the coupling device.

The invention is therefore based on the task of creating a synchronous motor with a starter device offering a relatively large angle of free run whilst still being of compact construction.

The synchronous motor according to the invention that is used to solve this task is characterised in that in the drive train between the rotor and the load, there is a shaft element inside which there is a cylindrical chamber in which a coaxial shaft is rotatably mounted, on which a threaded portion is disposed in a torque-proof but axially displaceable manner, with which a nut meshes, said nut being arranged in the chamber in a torque-proof but axially displaceable manner.

When the shaft element, or the shaft which is rotatably mounted inside the shaft element, is rotated, either the nut runs along the threaded portion until it reaches one of the end positions in which it comes to a stop, and the threaded portion is displaced axially if rotation continues. These steps may, however, also take place in the reverse order. Whatever the case, the rotary movement of the nut and the axial displacement of the threaded portion add up to a certain play which permits the starting motor a certain degree of free run before a load has to be carried.

It was stated that the chamber should be located in a suitable position inside the drive train between the rotor of the motor and the load, e.g. a pump wheel. All advantageous solution is to accommodate the chamber directly inside the rotor of the motor. Alternatively, the chamber can also be disposed in the hub of the pump wheel to be driven, or of another load.

As mentioned, an advantageous solution is to accommodate the chamber in the rotor of the motor. In this case, as; stated above, a rotatable shaft is mounted inside the rotor. The overall drive is characterised in that the rotor is provided with a coaxial bore in which a shaft is rotatably mounted to form the output shaft of the motor, and in that in one part or the rotor, the coaxial bore is enlarged to form a cylindrical chamber in which a threaded portion is fixed to the output shaft in a torque-proof but axially displaceable manner, and in that provided inside the chamber there is a nut which engages with the threaded portion in a torque-proof but axially displaceable manner in relation to the rotor.

The chamber with the arrangement comprising the threaded portion and the nut may also be disposed at some other point along the drive train, inside the load, for example, the hub of a pump wheel, for example.

As mentioned, the nut is arranged in the chamber in a torque-proof but axially displaceable manner. The threaded portion can also be disposed on the shaft such that it is immobile in the axial direction if the shaft as a whole permits a certain axial displacement within the rotor. Otherwise, the threaded portion would have to be axially displaceable on the shaft.

When the rotor starts to rotate, the nut which is disposed inside the chamber in a torque-proof manner is carried with it in the direction of rotation. It therefore screws itself along the threaded portion in the axial direction until reaching one end of the chamber against which it abuts. Further rotation of the nut together with the rotor results in the threaded portion, which is fixed to the output shaft, being screwed out of the nut to end up abutting against the other end of the chamber. As this happens, the shaft is pushed backwards at the same time. It is not until this moment that the rotation of the rotor is permanently transferred to the output shaft. The starter coupler is then engaged.

For the purpose of additionally enlarging the starter path of the synchronous motor, the torque-proof engagement between the rotor and the nut can be provided with a degree of play. i.e. the nut can be rotatable through a limited angle in relation to the rotor before the torque-proof engagement takes effect. To achieve this delayed drive engagement the circumference of the nut may be provided with for example, a cam which interacts with a corresponding cam on the inside of the chamber in the rotor. One cam respectively is sufficient, but several cants may also be provided if deemed necessary to guarantee long-term durability, for example.

Elastic buffer discs are preferably provided at both ends of the chamber to cushion the impact of the nut on the one hand and of the threaded portion on the other.

Preferred embodiments of the invention will be described below with reference to the enclosed drawings, in which

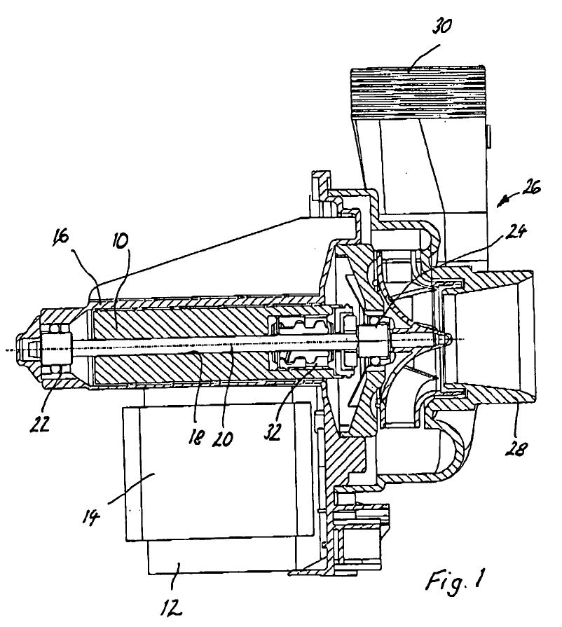

FIG. 1 is an overall view of a synchronous motor according to the invention;

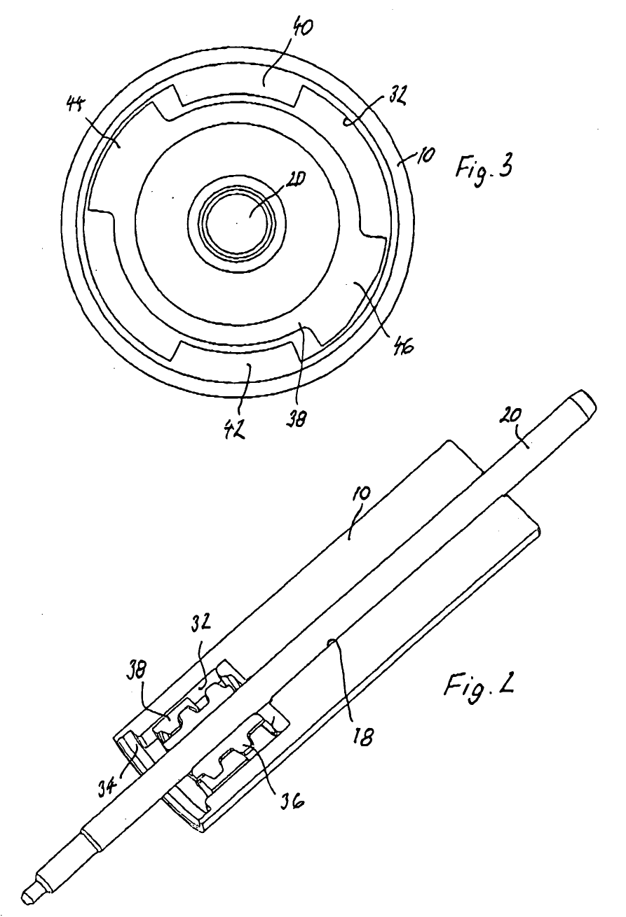

FIG. 2 is an axial cross-section of the rotor of the motor of FIG. 1 in a slightly enlarged view;

FIG. 3 is another enlarged cross-section through the rotor in the region of a chamber inside the rotor;

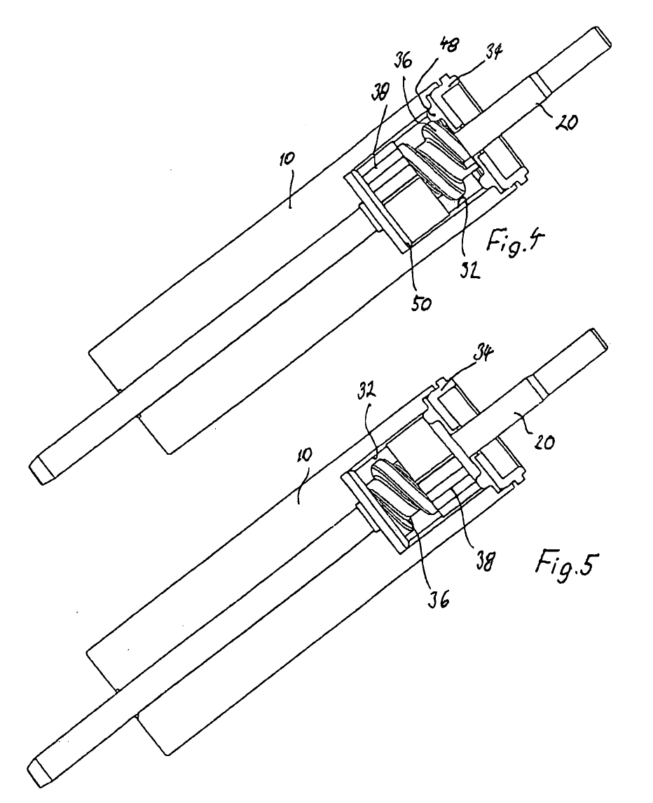

FIG. 4 is another axial cross-section of the rotor in the initial phase of the motor start-up;

FIG. 5 equates with FIG. 4, but shows the rotor at a later stage of the start-up process.

A synchronous motor according to the invention compromises as its essential component a permanent-magnetic rotor 10 and a coil 14, made e.g. from copper wire, disposed on a stator core 12. The rotor 10 is separated from stator core 12 with coil 14 by means of a pipe-shaped housing 16, referred to in practice as a can. The layout of a synchronous motor is known in expert circles and need not be described in further detail here.

In the embodiment shown, there is, inside rotor 10, a coaxial bore 18, inside which there is a rotatable shaft 20, mounted in bearings 22,24 in the ( ) housing. Shaft 20 can rotate in relation to rotor 10.

Rotor 10 is obviously also rotatable in relation to shaft 20. This mutual rotatability of rotor 10 and shaft 20 is exploited here. There is it delay before the rotation of rotor 10, which starts when the synchronous motor is switched on, is transferred to shaft 20, which forms the actual output shaft and carries the load with it, as will be explained below.

In the example shown, the load is formed by a feed pump 26 with a suction flange 28 and a pressure flange 30. The shaft 20 of the synchronous motor is drive-connected to an impeller (not shown) of feed pump 26.

Inside rotor 10 there is a coaxial, cylindrical chamber 32, which is shown ont a slightly larger scale in FIGS. 2, 4 and 5. In these figures of the drawings, the chamber is located in an end portion of rotor 10, and it is sealed by a lid 34. The shaft 20, which extends through the entire length of rotor 10 and beyond, naturally also runs through chamber 32 and lid 34.

Inside chamber 32 there is a threaded portion 36, onto which a nut 38 it screwed.

Nut 38 is arranged inside chamber 32 in a torque-proof but axially displaceable manner. The threaded portion 36 is fixed to shaft 20.

In the embodiment shown here, however, the torque-proof connection between rotor 10 and nut 38 only takes effect after a given limited angle of rotation α. FIG. 3 shows a cross-section through rotor 10 with the chamber 32 and the nut 38. On the inner walls of chamber 32 there are ribs 40.42 disposed in two opposite positions, which extend over the entire length of the chamber and there are corresponding ribs 44.46, extending over the entire length of nut 38, disposed on the outer surface of the latter.

The mode of functioning of the illustrated claw coupling-type connection between rotor 10 and nut 38 is directly visible in FIG. 3. When rotor 10 is rotated, i.e. the motor is switched on, claws 40.42 on the inside of chamber 32 first move through angle until they come up against claws 44.46 of the nut. From this moment onwards nut 38 is set in rotation. One claw on the nut and one in the clamp would be sufficient.

This claw connection forms the first part of the free run or play in the connection between rotor 10 and feed pump 26 according to the invention.

The second part of the free run is achieved in that when nut 38 is rotated, it is moved axially along threaded portion 36 until it abuts against the right end of chamber 32 in FIGS. 4 and 5. Nut 38 is shown in this position in FIG. 5. As shown in FIG. 5, nut 38 abuts against an elastic stopper disk 48 at the right end of chamber 32. This stopper disk 48 is disposed on the inside of a lid 34, which seals the chamber 32, which is open towards the end of rotor 10, from its end. The stopper disk dampens both the stopping impact and the stopping noise. The nut running along the threaded portion fortes the second part of the overall free run.

Once nut 38 has abutted against stopper disk 48, the continued rotation executed by nut 38 together with rotor 10 results in the threaded portion 36 being twisted towards the left in FIG. 5 and out of the nut.

This continues until the threaded portion 36 abuts against an elastic stopper disk 52 at the left end of chamber 32 in FIGS. 4 and 5. As the threaded portion moves backwards, the shaft is pushed backwards inside the rotor and its bearings, as will be explained in more detail below. In its run-back position the threaded portion 36 is held immobile. Nut 38 and the threaded portion 36 are now engaged in an immobile manner. The nut transfers the rotation of rotor 10 to the threaded portion 36, which transfers the rotation to shaft 20 since the threaded portion 36 is fixed to shaft 20.

The phase of axial movement of nut 38 along the threaded portion 36 forms the second part of the free run, and the phase of axial movement of the threaded portion 36 forms the third part.

The threaded portion 36 and the inner thread of nut 38 need to be contrived so that there is no possibility of any self-Inhibition. Furthermore, lubricating grease may be provided in chamber 32, which not only helps to make the thread easier to move across, but also to dampen the associated noise.

It has already been mentioned that when the threaded portion runs back into the left end position in FIGS. 4 and 5, shaft 20 is pushed back, too. With this embodiment, this axial displacement of shaft 20 can be used to ensure that the motor starts up in the correct direction of rotation. According to FIG. 1, shaft 20 directly carries the feed pump impeller. If the nut 38 and the threaded portion 36 have moved into the “wrong” end positions contrary ( ) to the above description, shaft 20 is not pushed back towards the left in FIGS. 4 and 5 as described, but pushed forward to the right in relation to these Figures. Hence the impeller ends up in a forward position inside the pump housing, a position in which a bypass is formed between the suction port of the pump housing and the impeller. The consequence of this bypass is that the power consumption of the motor is significantly greater than when the impeller runs in the suction port of the pump housing.

If the power of the motor is contrived so that the motor will stop if the power consumption is “wrong”, the motor would be forced to restart in the opposite direction. Hence the axial displacement of the shaft can be used to ensure the impeller starts up in the right direction.

What is claimed is:

1. Synchronous motor comprising:
a drive connection between the motor and a load,
a starter device in the drive connection between the motor and the load, and
a driven rotor,
the starter device including a shaft element in the drive connection between the rotor and the load, the shaft element including:
a cylindrical chamber,
a coaxial shaft rotatably mounted in the cylindrical chamber,
a threaded portion disposed on the coaxial shaft in a torque-proof but axially displaceable manner, and
a nut which meshes with said threaded portion, said nut being arranged in the chamber in a torque-proof but axially displaceable manner.

2. The synchronous motor of claim 1, wherein:
the rotor is provided with a coaxial bore in which the shaft is rotatably mounted to form an output shaft of the motor,
in one part of the rotor, the coaxial bore is enlarged to form the cylindrical chamber in which the threaded portion is fixed on the output shaft in a torque-proof but axially displaceable manner, and
the nut is provided inside the chamber and engages with the threaded portion in a torque-proof but axially displaceable manner in relation to the rotor.

3. The synchronous motor of claim 1, further comprising elastic stopper disks at both ends of the chamber.

4. The synchronous motor of claim 1, wherein the chamber is at least partially filled with a lubricating grease.

5. The synchronous motor according to claim 1, wherein the chamber is positioned at one axial end of the rotor and is sealed by a lid.

6. The synchronous motor of claim 1, further comprising at least one cam on an inner wall of the chamber and on an outer circumference of the nut, respectively, which results in the nut being carried by the rotor once the rotor has moved through a corresponding angle of rotation.

7. Synchronous motor comprising:
a drive connection between the motor and a load,
a driven rotor, and
a starter device in the drive connection between the motor and the load, the starter device including a shaft element in the drive connection between the rotor and the load, the shaft element including:
a cylindrical chamber,
a coaxial shaft rotatable mounted in the cylindrical chamber,
a threaded portion disposed on the coaxial shaft, and
a nut which meshes with said threaded portion, said nut being arranged in the chamber in a torque-proof but axially displaceable manner,
the driven rotor provided with a coaxial bore in which the shaft is rotatably mounted to form an output shaft of the motor, the coaxial bore being enlarged in one part of the rotor to form the cylindrical chamber in which the threaded portion is fixed to the output shaft in a torque-proof and axially immobile manner,
the nut being provided inside the chamber and engaging with the threaded portion in a torque-proof but axially displaceable manner in relation to the rotor, and
when the shaft is axially displaced by the threaded portion as the threaded portion moves into an end position, a working element disposed on the shaft ends up, as a result of one of the two directions of rotation, in a position in which a scheduled power consumption is exceeded.
